(19) United States
(12) Patent Application Publication
(10) Pub. No.: US 2023/0001477 A1
(43) Pub. Date: Jan. 5, 2023

(54) METHOD OF MAKING NANOPARTICLES IN AN AQUEOUS SOLUTION PROVIDING FUNCTIONALIZATION AND HINDERED AGGREGATION IN ONE STEP

(71) Applicant: Ludwig-Maximilians-Universität München, München (DE)

(72) Inventors: Linh Nguyen, München (DE); Amelie Heuer-Jungemann, Krailling (DE); Tim Liedl, München (DE); Maximilian Julius Urban, München (DE)

(21) Appl. No.: 17/756,219

(22) PCT Filed: Nov. 20, 2020
(86) PCT No.: PCT/EP2020/082866

§ 371 Date: May 19, 2022

(30) Foreign Application Priority Data
Nov. 22, 2019 (EP) 19210989.0

(51) Int. Cl. B22F 1/17; B22F 1/0545; B22F 1/065; B22F 1/102; B22F 1/145

(52) U.S. Cl. CPC B22F 1/17; B22F 1/0545; B22F 1/065; B22F 1/102; B22F 1/147; B22F 2301/255; B22F 2303/01; B22F 2304/05; B82Y 40/00

(57) ABSTRACT

The invention relates to a method of making a functionalized nanoparticle in an aqueous solution, wherein a chemical functionalization of a metal nanoparticle in the aqueous solution is provided and the aqueous solution comprises water and ingredients. The ingredients comprise at least the metal nanoparticle, a thiol of the form R—SH, where R represents a substituent, and a silver compound. The invention further relates to a plurality of functionalized nanoparticles according to the method, wherein each of the plurality of functionalized nanoparticles comprises a metal core, a silver coating and a sulfide bond substituent. The invention also relates to a lateral flow test method and device.

The present invention relates to the field of synthesis of nanoparticles, in particular to the synthesis of metal nanoparticles, which exhibit unique optical properties and therefore are of particular interest in many key areas including photonics, electronics, imaging, medicine, catalysis, and bio-sensing. This in particular holds for the case of anisotropic metal nanoparticles, since their strongly shape-dependent properties make them very versatile in their applications.

In addition to the size- and shape-controlled synthesis of nanoparticles, the precise organization of metal nanoparticles in a controlled manner become an important tool for manipulating light, in the respective fields of photonics and electronics. For example, under resonant excitation, metal nanoparticles have the unique ability to concentrate the free-space optical field within subwavelength regions, wherein this ability is based on surface plasmon excitation. The overall plasmonic behavior of gold (Au) and silver (Ag) nanoparticles is similar, however, silver is known to give higher field effects due to a lower plasmon damping leading to more intriguing optical properties and thus to enhanced optical performances.

Ag nanoparticles are known to have excellent optical properties, however, they are chemically very unstable compared to their Au counterparts. Therefore, despite their weaker optical performance, Au nanoparticles are favored for optical studies and have become widely used. Further, the cooperative behavior of bimetallic Ag—Au nanoparticles is a very active field of research.

However, Ag nanoparticles are sensitive to light induced disintegration and aggregation which has so far strongly limited their potential application as single metal component but also in bimetallic compositions.

The development of bimetallic Au—Ag nanoparticles with synergistic effects offered a compromise by providing stability as well as cooperative and enhanced optical behavior. The use of stabilizing agents, typically large molecules adsorbing to the particle's surface, avoids aggregation and effectively increases stability.

Common stabilizers like the surfactant (deutsch: Tensid) Cetyltrimethylammonium bromide (CTAB) and sodium citrate can be employed to increase stability, nonetheless, the overall lifetime of such silver nanocrystals is still shorter compared to their gold counterparts. Other stabilizers like high molecular weight polymers (e.g. polyvinyl pyrrolidone (PVP), PEG,) impart a higher degree of stabilization. However, due to their steric effect, subsequent ligand replacement with biomolecules such as DNA is hindered.

Typical methods for the functionalization of Au nanoparticles with DNA, such as the salt-aging method, have proven successful, but could only be partially applied to Ag nanoparticles, for example depending on their shape greater care needs to be taken to avoid Ag nanoparticle aggregation, through additional time-consuming steps thereby increasing effort and inconvenience. While individual reports claim successful functionalization of prisms and wires with DNA via such methods, yields and reproducibility is highly questionable.

According to the salt-aging method, in the presence of an excess amount of DNA, NaCl is gradually added to the DNA/Au (or DNA/Ag)—nanoparticle mixture upon which more DNA becomes attached to the nanoparticles. With increasing NaCl addition more and more DNA can be conjugated to the nanoparticle surface, which in turn increases the stability of the particles. This iterative process takes 1-2 days until stable conjugates are formed. Consequently, although the salt aging method is commonly used by the scientific community to produce DNA-Au (or DNA/Ag) NP-conjugates, it is very time-consuming due to a slow reaction and a large number of steps making it inconvenient for broad applications. A further disadvantage is that DNA-Ag nanoparticles prepared according to the salt aging method already degrade throughout the process of formation, which results in poor yields. Further, such particles can be stored only in the absence of light but also degrade over short periods of time, typically one or few weeks, also in the dark.

In particular, anisotropic Ag nanoparticles, i.e. substantially non-spherical Ag nanoparticles, are very unstable and require careful handling. A major disadvantage of the salt-aging method is that this method is restricted to functionalizing substantially spherical Ag nanoparticles. The salt-aging method is basically not suitable to functionalize and stabilize Ag nanoparticles of non-spherical shapes, in particular Ag-nanorods or Au-nanorods having a Ag-shell. Consequently, the low yields, poor reproducibility and the time consuming preparation of the salt-aging method has become a major bottleneck for ease-of-use and therefore has impeded a full exploitation of the potential application of Ag nanoparticles and particle conjugates and complexes involving Ag particles.

Hence, because of the above mentioned aspects, it is in particular of great interest for research and industry to access commercial DNA-functionalized silver nanoparticles and to arrange them within various assemblies, such as for example rows, rings, star-shapes, lattices (2D and 3D), of varying sizes also within the respective assembly, of varying materials also within the respective assembly, as the optical behavior of such arranged interacting Ag nanoparticles is tunable and versatile but, as of yet, poorly studied due to the above-mentioned shortcomings in stability and functionality.

Also other relevant aspects of silver nanoparticles such as catalytic or anti-inflammatory properties can be explored with greater rigor if the particles remain intact, that is the particles do not aggregate during the study. Longer activity with less toxicity of colloidal silver could be achievable this way.

Therefore, it is an object of the present application to provide a method for fabrication of nanoparticles, which are easy to synthesize that is the production of the nanoparticles can be performed within a short period of time.

It is a further object of the invention to provide a plurality of nanoparticles which are functionalized and prevented from aggregation over a long period of time, which at least is a period longer than two weeks.

It is a further object of the invention to provide a test method, in particular a lateral flow test, and a test device for a lateral flow test, and a method of producing the test device, which utilize the functionalized nanoparticles according to the invention.

A solution to this problem is provided, in particular, by the teaching of the independent claims, specifically by a method according to claim 1 and a plurality of functionalized nanoparticles according to claim 7 or 12, and by the test device of claim 14 or the method of claim 15 for producing the test device. Various preferred embodiments presented by the invention are particularly provided by the teachings of the dependent claims.

A method, according to the invention, of preparing a functionalized nanoparticle, which comprises or consists of a metal core, a silver coating and a sulfide bond substituent, in an aqueous solution, the method comprising a step of chemical functionalization of a metal nanoparticle in the aqueous solution, wherein the aqueous solution comprises or consists of water and ingredients, wherein the ingredients comprise or consist of the metal nanoparticle, a thiol of the form R—SH, where R represents a substituent, and a silver compound, the substituent being, preferably, organic, and having, preferably, a functional group.

The functional group, respectively preferably, comprises or consists of a carboxyl group (—COOH), an aldehyde group (—CHO), a hydroxyl group (—OH), an amino group (—NH2), an amide group (—CONH), and/or wherein the substituent comprises a carboxyl group, an amino acid, a protein, an antibody, a virus or a hormone, or two or more thereof.

A nanoparticle hereby relates to nanometer sized structures, i.e. nanoparticles. A functionalized nanoparticle hereby refers to a nanoparticle, which has a functional substituent attached to it. The function of the functional substituent is related, in particular, to the effect of preventing aggregation of the functionalized nanoparticle in solution. The substituent is linked to the nanoparticle's surface. Linkage of the substituent to the nanoparticle's surface is achieved at least through a binding group. The binding group, also referred to as “binding agent” within the present description of the invention, at least forms a bond with the substituent and with the surface of the nanoparticle. In particular the binding group forms a bond with the silver surface of the nanoparticle. The binding group used for attaching the substituent to the nanoparticle is a thiol moiety of the form R—SH. The substituent is bonded to the silver via sulfur. That is the substituent is bonded to a silver atom via a sulfide bond, whereas the silver atom is attached to the surface of the metal nanoparticle. That is, functionalization of the nanoparticle through binding of a plurality of substituents to a plurality of respective silver atoms can occur during deposition of the respective silver atoms onto the nanoparticles surface.

The substituent can be any molecule, which is capable of having a binding group (R—SH). Within the present description of the invention, the terms “substituent” and “ligand” have the same meaning, if not defined to the contrary. In particular, the thiol, which includes the substituent, comprises or consists of mercaptopropionic acid (MPA), mercapto methoxy polyethylene glycol (mPEG-SH), PEG-SH, or most preferably DNA-SH. Preferably, the thiol, which includes the substituent, comprises at least one of 2,5,8,11,14,17,20-Heptaoxadocosane-22-thiol, or CH3O(CH2CH2O)nCH2CH2SH. The substituent preferably further comprises a functional group, e.g. carboxyl group, an amino acid, a protein, an antibody, a virus or a hormone.

A metal nanoparticle hereby forms the core of the functionalized nanoparticle. The metal nanoparticle comprises or consists of a metal element, e.g. Au. Upon initialization of a wet chemical reaction the silver of the silver compound is deposited on the surface of the metal nanoparticle.

The binding agent is attached to the silver surface, which covers the metal core nanoparticle through a chemical binding of the thiol-group (—SH). The binding agent is attached to the silver surface, which covers the metal core nanoparticle through chemically binding of the thiol-group (—SH) during the reaction, in particular during the wet chemical reaction. That is, during the silver deposition on the surface of the metal core nanoparticle binding of the substituents occurs. Upon this reaction a color change of the solution visibly occurs.

Thereby most preferably a sulfide bond is formed. Chemical binding comprises a covalent bond, an ionic bond or a coordinate bond.

Chemical functionalization refers to binding of the substituent onto the surface of the nanoparticle having a metal core.

The water of the aqueous solution preferably is a purified water, preferably a distilled water, most preferably a double-distilled water (abbreviated “ddH2O”). Storage of the functionalized nanoparticle according to the invention preferably takes place in aqueous solution, preferably in ddH2O, preferably in the absence of a buffer.

According to the method provided by the invention an aqueous solution comprising water and the essential ingredients of at least a metal nanoparticle, a thiol of the form R—SH and a silver compound is used. A wet chemical reaction is started. In particular upon adding a pH increasing ingredient to the aqueous solution the wet chemical reaction is initialized. Upon initiation of the reaction, silver of the silver compound is deposited on the surface of the metal nanoparticles. Further, the thiolated substituents and or those substituents comprising an SH-group attach to the silver.

The method provided by the invention advantageously prevents agglomeration of the functionalized nanoparticles. In particular, the method turns out to effectively prevent agglomeration of the functionalized nanoparticles even after freezing, when the solution of nanoparticles is thawed again. Hence, the as-prepared functionalized nanoparticles can be stored in the freezer. Thereby colloidal stability over a long time is ensured. Preferably, colloidal stability over at least two weeks, preferably longer than three weeks, preferably longer than four weeks, preferably longer than two month, the period preferably extending up to three weeks, preferably four weeks, preferably two month, preferably three, four five or six month. The period being preferably over at least two month, or over at least half a year is ensured. In a freezer, in particular at −18° C., the period can be between several month and several years.

The nanoparticles can be stored under ambient temperature and/or under air—meanwhile the quality of the nanoparticles only slowly changes by a depletion of the Ag shell around the metal core, over several weeks. The method provided allows easy control of the Ag shell thickness. The method further allows ease of selection of different types of substituents. Choosing, in particular DNA modified strands as the substituent and adapting the density as later described, aggregation is hindered. Hence, the method provided offers the person skilled in the art easy to control parameters for advantageously adjusting the solution to prevent aggregation specifically.

The method further advantageously provides the preparation of nanoparticles in short time, e.g. within one hour after the wet chemical reaction has been started. An initial color change of the solution containing the functionalized nanoparticles followed by the color remaining constant indicates the wet chemical reaction being finished. Adsorption spectroscopy of a small sample probe of the solution can be used to ultimately prove the reaction has terminated when no further change in the spectrum is observed. This can be done in parallel to the actual reaction, to monitor the progress of the reaction.

Moreover the method advantageously functionalizes and at the same time prevents aggregation of the functionalized nanoparticles in one step. That is, no further modification of the functionalized nanoparticles is needed, e.g. synthesis of Ag coated particles in a first reaction and functionalization in a second subsequent separate reaction.

Using the terms defined by the present description of the invention, the invention also refers to at least one functionalized nanoparticle or a plurality of functionalized nanoparticles, which are in particular synthesized by the method according to the invention, wherein each of the plurality of functionalized nanoparticles comprises
a metal core,
a silver coating and
a sulfide bond substituent.

The sulfide bond substituent corresponds to the substituent —R as already defined, which is linked to the metal core or the silver, respectively, via a sulfide bond. The plurality of functionalized nanoparticles produced according to the invention does effectively suppress the formation of aggregates, or clusters or agglomerates in the aqueous solution. The property of the plurality of functionalized nanoparticles or of the solution containing the functionalized nanoparticles to hinder or prevent aggregation or agglomeration or the formation of clusters of the particles is also phrased as stability.

According to the invention, the functionalized nanoparticles essentially comprise a metal core, a silver coating and a sulfide bond substituent.

Silver is deposited on the surface of the metal nanoparticles and sulfide bonds are formed on the silver surface. A silver-coating is formed around the metal core nanoparticle. The metal core is the metal nanoparticle. Thereby, the core may also be seen as a seed nanoparticle upon which the silver is deposited by wet chemical reaction in the form of a silver layer. The coating at least partially covers the metal nanoparticle. Thereby the silver layer is formed. The —SH group of the substituent forms a sulfide bond with a silver atom of the silver layer. Thereby the substituent becomes linked to the layer. The nanoparticle is functionalized through linkage of the substituent to a silver atom of the silver layer. Further substituents form sulfide bonds to other silver atoms of the silver layer at different locations on the silver layer. The functionalized nanoparticles are further stabilized through the density of the substituents attached to the surface of the particle thereby forming a stabilizing layer. The stabilizing layer or functional layer is visible by use of common techniques such as electron microscopy, but also appears in the X-ray scattering data.

Advantageously after preparation, the solution of the functionalized nanoparticles is immediately usable. The solution of functionalized nanoparticles is immediately usable even after long term storage, including freezing and thawing. Preferably, the solution of functionalized nanoparticles is stable after multiple times of freezing and thawing, in particular at least one time freezing and thawing, or two time freezing and thawing or 10 times freezing and thawing or 50 times freezing and thawing.

In particular the solution of nanoparticles is stable after multiple centrifugation cycles and re-dispersion, preferably in different salt containing aqueous media. Preferably the solution of nanoparticles is stable, after 5 times centrifugation and redispersion, or after 10 times centrifugation and redispersion or after 20 times centrifugation and redispersion.

In particular the solution of nanoparticles is stable over a period of two weeks, preferably over a period of at least two month or most preferably over a period of at least half a year. The stability of functionalized nanoparticles in solution can be derived from the color of the solution, which alters upon aggregation that is the solution becomes transparent. Alternative techniques to prove stability are electron microscopy, X-ray scattering, or absorption spectroscopy. For example, through analyzing a small portion of the solution containing the functionalized nanoparticles by means of a conventional absorption spectrometer.

In the following, preferred embodiments of the method are described or can be gathered from the description, which can be arbitrarily combined with each other or with other aspects of the present invention, unless such combination is explicitly excluded or technically impossible.

According to a second embodiment of the method, wherein silver of the silver compound is deposited on the metal nanoparticle by wet chemical reaction. Silver coating of the metal nanoparticle can for example be examined using conventional X-ray diffraction (XRD).

According to a third preferred embodiment of the method, the ingredients are provided in one step, wherein a plurality of the metal nanoparticles is functionalized. The method further prevents aggregation of the plurality of functionalized nanoparticles after the wet chemical reaction has finished.

The ingredients are provided in a single step wherein upon initiation of the wet chemical reaction, the functionalization is started. Functionalizing the nanoparticles by use of the thiol binding agent also prevents aggregation of the nanoparticles. Hence, in one step, functionalization and stability is achieved. Therefore, compared to existing methods this strategy is advantageously convenient.

Deposition of the silver atoms onto the metal core nanoparticle increases the size of the nanoparticles. Stability of the functionalized nanoparticles that is the colloidal stability can be observed by, for example electron microscopy. Further the color of the solution containing the functionalized particles changes upon silver growth, thereby allowing observation of the stability by bare eye or by use of an absorption spectrometer. In contrast, upon aggregation the solution containing the functionalized nanoparticles would become optically transparent.

According to a fourth embodiment of the method, the substituent comprises a nucleotide, preferably an oligonucleotide, in particular a RNA, PNA, or DNA strand, or a methoxy polyethylene glycol (mPEG) or a polyethylene glycol (PEG).

This allows for the fabrication of DNA functionalized and stabilized nanoparticles with exceptionally high stability. The long-term stable nanoparticles exhibit improved optical properties, e.g. enhancement of Raman signals, compared to their Au equivalents, for example Au nanoparticles having substituents bound onto the gold surface instead.

The DNA-conjugation further advantageously increases the particles biocompatibility, which allows for direct use in biomedical applications and thus makes the necessity for replacing conventional stabilizing agents by inert molecules redundant. Furthermore, the DNA-functionality allows for the organization of these particles on a DNA origami platform which paves the way to shaping and creating new surface plasmon based phenomena.

According to a fifth embodiment of the method the thiol modified substituent comprises MPA.

The method provided advantageously also works with uncharged substituents comprising, in particular, molecules smaller than DNA molecules, which is the case for some mPEG and PEG.

According to a sixth preferable embodiment of the method, the thiol, which includes the substituent, comprises sequences of an oligonucleotide, in particular DNA bases, comprising, preferably, adenine (A), cytosine (C), guanine (G) and/or thymine (T), having, in particular one of the following patterns: HS-5′TTTTTTTTTTTTTTTTTTT3′, or HS5′AAAAAAAAAAAAAAAAAAA3′, or HS-5′GGGGGGGGGGGGGGGGGGG3′, or HS5′00000000000000000003′, or HS-5′TTCTCTACCACCTACAT3′, alternatively, the oligonucleotide consist of 5′TTTTTTTTTTTTTTTTTTT3′, or 5′AAAAAAAAAAAAAAAAAAA3′, or 5′GGGGGGGGGGGGGGGGGGG3′, or 5′CCCCCCCCCCCCCCCCCCC3′, or 5′TTCTCTACCACCTACAT3′. Wherein the modified DNA sequences are preferably purchased and thus readily added to the aqueous solution. Furthermore, preferred sequences are:

| Name | Sequence |
|---|---|
| T19-SH | HS-5′TTTTTTTTTTTTTTTTTTT3′ |
| T15-SH | HS-5′TTTTTTTTTTTTTTT3′ |
| T8-SH | HS-5′TTTTTTTT3′ |
| A19-SH | HS-5′AAAAAAAAAAAAAAAAAAA3′ |
| G19-SH | HS-5′GGGGGGGGGGGGGGGGGGG3′ |
| C19-SH | HS-5′CCCCCCCCCCCCCCCCCCC3′ |
| Random1-SH | HS-5′TTCTCTACCACCTACAT3′ |
| Random2-SH | HS-5′TTAATCTCGCAACAGG3′ |

The disclosed different modified DNA sequences positively impact the stability of the functionalized nanoparticles. In particular, the HS-5′TTTTTTTTTTTTTTTTTTT3′ thiol modified substituents are attached to a respective silver atom of the silver shell of a respective nanoparticle. Gel—electrophoresis may serve to prove that the charged substituents are linked to the nanoparticles.

According to a preferred seventh embodiment of the method the silver compound comprises inorganic silver compounds.

According to a preferred eighth embodiment of the method the silver compound comprises and or consists of silver nitrate compounds.

According to a ninth preferred embodiment, wherein the metal nanoparticles used as core metal nanoparticles are nanospheres and/or nanorods, nanocubes, nanowires, nanostars. Hence the metal nanoparticles can comprise spherical and non-spherical nanoparticles, or a mixture thereof, wherein the shape of the nanoparticles advantageously contributes to the properties of the resulting binding agent functionalized nanoparticle. In particular, the optical properties, e.g. field enhancement near their surface which can be exploited to enhance, e.g. the Raman scattering or shorten the fluorescence lifetime of a near-by molecule, making those functionalized and stabilized nanoparticles in particular interesting for a wide field of applications related to e.g. biological sensors. It is a major advantage of the invention that non-spherical Ag nanoparticles can be functionalized and stabilized, while the known salt-aging method is limited to functionalizing substantially spherical Ag nanoparticles and Au nanoparticles without Ag-shell.

According to a tenth embodiment the prevention of the aggregation of the functionalized nanoparticles occurs for a time period lasting at least for 2 weeks. Or in a further preferred embodiment, the stability of the functionalized particles in solution is achieved for a time period lasting for at least 2 month or further preferred for at least half a year or further preferred for at least a year.

Further preferably the DNA in the solution containing the functionalized nanoparticles does hinder aggregation of the functionalized nanoparticles upon freezing and after thawing. Hence, the solution containing the functionalized particles can preferably be stored frozen over a time period lasting for one month, or for half a year or for a year.

Stability of the functionalized nanoparticles can be observed through electron microscopy or inspecting the color of the solution by eye, or by absorption spectroscopy, whereas upon aggregation the solution containing the functionalized nanoparticles becomes optically transparent. Oxidation of the nanoparticles leads to changes in shape which can be observed in an early state by electron microscopy. Further oxidation can be observed by absorption spectroscopy or by eye. Aggregation can be observed by all three methods.

In a preferred eleventh embodiment the silver forms a shell around the metal nanoparticle and a thiol modified substituent attaches onto the surface of the silver shell by forming a sulfide bond with the silver of the shell. In the preferred case of DNA substituents, formation of the sulfide bond between the shell and the substituent can be observed by gel-electro-phoresis and transmission electron microscopy. Alternatively, X-ray scattering is applied.

The shell preferably is formed by deposition of the silver atoms onto the metal core nanoparticle. The shell increases thereby the size of the nanoparticle. Thereby the aspect ratio of the functionalized nanoparticle can be altered. The thickness of the shell preferably depends on the amount of silver contained in the aqueous solution. That is, the amount of silver that is formed by reduction of the silver compound which determines the thickness of the silver shell. The shell preferably fully covers the metal core. Optical absorption spectroscopy thus may serve to ensure the coverage of the metal core by the silver shell, leaving a silver specific footprint in the absorption spectrum. Attachment of the thiolated substituents can be observed by X-ray scattering in combination with electron microscopy.

This advantageously allows tuning the optical properties of the functionalized particles according to a specific application.

In the following, preferred embodiments of the plurality of functionalized nanoparticles are described or can be gathered from the description, which can be arbitrarily combined with each other or with other aspects of the present invention, unless such combination is explicitly excluded or technically impossible.

In a first preferred embodiment of the functionalized nanoparticles according to the invention the metal cores of the nanoparticles comprise the following metals: Au, Ag, Al, Pt, Pd, Cu, Rh, Fe. In a further preferred embodiment the plurality of metal cores is made of Au, or Ag. Most preferably the plurality of metal cores is made of Au nanoparticles. That is, preferably the metal core material in the aqueous solution is made of only one type of metal, which preferably is Au.

According to a second preferred embodiment of the functionalized nanoparticles the silver coating of each of the functionalized nanoparticles forms a shell around the metal core and the metal core is at least partially covered by the silver shell.

Formation of the shell, which is accompanied by functionalization of the nanoparticle can be observed by X-ray scattering, whereas the lattice constant of the silver layer is obtained.

According to a third preferred embodiment of the functionalized nanoparticles according to the invention the thiol modified DNA protrudes from the silver shell. That is, the DNA preferably points upwardly in a direction away from the surface of the silver shell. This advantageously offers reaction sites of the DNA to further binding partners, e.g. surface selective docking reactions. Protrusion of the DNA can be observed from X-ray spectroscopy and electron microscopy.

In a further fourth preferred embodiment of the functionalized nanoparticles the DNA length exceeds the thickness of the silver shell and thereby extends from the silver shell.

This preferably contributes to hinder the aggregation of the functionalized nanoparticles in solution. The over the surface distributed substituents form a layer around the silver shell, thereby stabilizing the particles. That is, the substituents form a stabilizing layer around the silver covered metal core.

Functionalization of the nanoparticles in solution preferably occurs within minutes. The reaction time of the wet chemical reaction preferably comprises 10 minutes, or further preferably comprises one hour. The functionalization of the nanoparticles in solution is thus finished preferably after 1 hour after the reaction has started. The reaction starts by increasing the pH of the solution. The absorption spectrum of the solution with the functionalized nanoparticles indicates that the reaction has finished that is, the spectrum remains constant. The wet chemical reaction is thus not hindered by steric effects, that is by non-covalent interactions of, for example those substituents already adsorbed to the surface.

The invention is also related to a test method and a test device for performing a lateral flow test, the test device including a test substrate and a plurality of functionalized nanoparticles according to the invention, which are produced by the method according to the invention of preparing a functionalized nanoparticle, and/or including one or a plurality of nanoscale objects, in particular DNA-origami, being functionalized with at least one functionalized nanoparticle synthesized by the method according to the invention. The invention is also related to a method of producing said test device, preferably containing the steps of a) providing a test substrate, b) applying the functionalized nanoparticles, which were made according to the method of the invention, to the test substrate.

The functionalized nanoparticles according to the invention are used in such a test method as a visual marker. A visual marked may be configured to detect a specific target contained in a sample fluid, in particular by specifically binding to the respective target.

The spectral properties, in particular the color of the functionalized nanoparticles, in particular when deposited on a test substrate, depend on the size and/or the geometry of the functionalized nanoparticles. Therefore, adjusting the size and/or the geometry of the functionalized nanoparticles may be used to provide functionalized nanoparticles of different color. In particular when using a chemical functionalization (of the functionalized nanoparticles) depending on the size and/or the geometry (of the functionalized nanoparticles), a multiplexing test method may be provided. The test method may be a multiplexing test method being configured to utilize different groups of functionalized nanoparticles, each group having a different color. A test device for performing a multiplexing test method may contain a first group of functionalized nanoparticles having a first characteristic size and/or geometry and additionally a second group of functionalized nanoparticles having a second characteristic size and/or geometry, the second size and/or geometry being different from the first size and/or geometry, and if more then two different visual markers are to be provided, even more groups of different functionalized nanoparticles having, respectively, differing size and/or geometry.

The test substrate may be a test strip. The test substrate may be a pad. The test, method, preferably, is lateral flow test. According to an embodiment, representing a lateral flow test, the test method operates by running a liquid sample along the surface of a pad with reactive molecules. A pad may contain an open-porous material, in particular a series of capillary beds, such as pieces of porous paper, microstructured polymer, or sintered polymer. For the purpose of applying a lateral flow test according to a preferred embodiment of the test method, the pad may act as a sponge and be able to hold an excess of sample fluid. A pad, preferably, has the capacity to transport a sample fluid, in particular a medical body fluid (e.g., urine, blood, saliva) spontaneously. A pad may contain a stack including a first conjugate pad layer and a second conjugate pad layer.

Further advantages, features and applications of the present invention are provided in the following detailed description of the exemplary embodiments and the appended figures. The same components of the exemplary embodiments are substantially characterized by the same reference signs, except if referred to otherwise or if other reference signs emerge from the context. In detail:

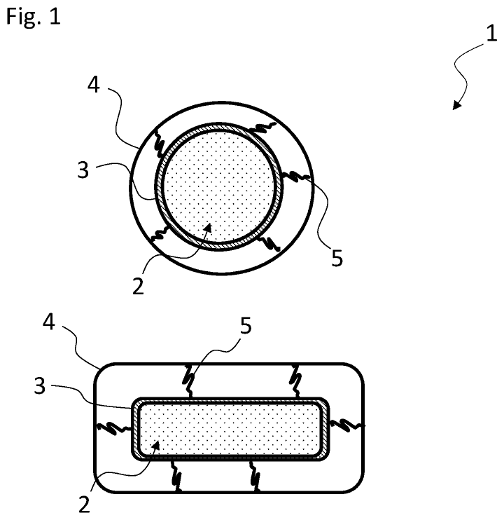

FIG. 1 schematically illustrates the cross sectional view of a spherical and a rod shaped functionalized nanoparticle according to the invention.

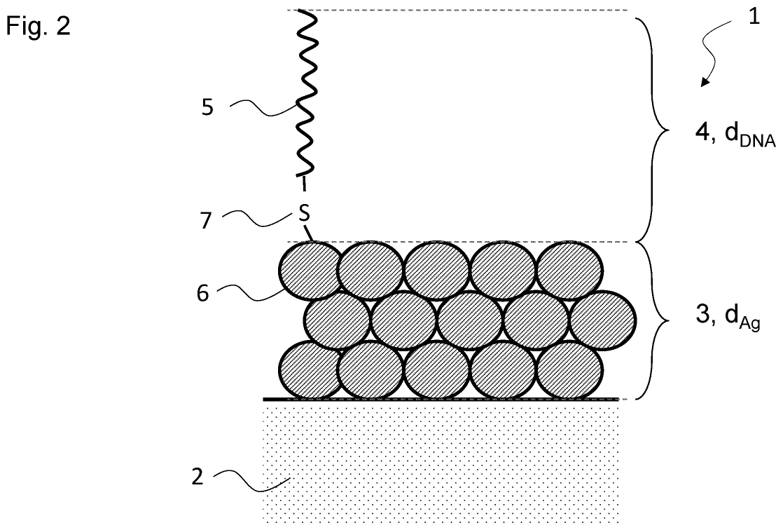

FIG. 2 schematically illustrates an enlarged cross sectional view of the functionalized nanoparticle according to the invention.

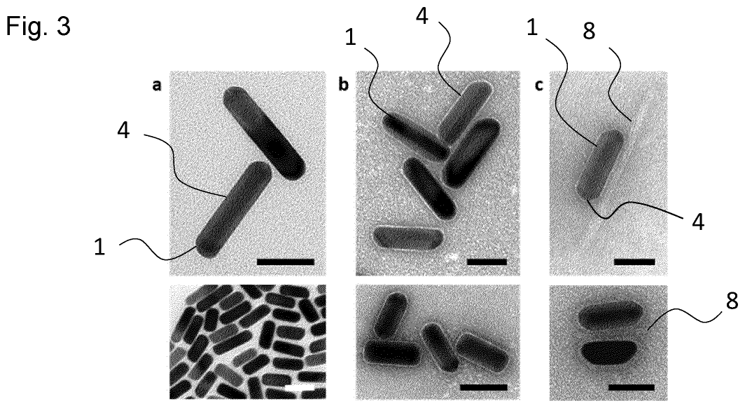

FIG. 3a shows a top and a bottom image. In the top image an electron microscopy recording of two Au/Ag rod shaped DNA functionalized nanoparticles according to the invention is shown. The bottom image shows a corresponding zoom out view of a plurality of Au/Ag DNA functionalized nanorods. The scale bar is 50 nm in each case.

FIG. 3b shows Au/Ag rod shaped DNA functionalized nanoparticles according to the invention (top and bottom zoom out image). The scale bar is 50 nm in each case. The density of the DNA substituents was further increased compared to FIG. 3a. The DNA functionalization layer then appears as a more prominent white layer around the Au/Ag nanorods (sample stained with Uranyl Formate).

FIG. 3c shows one (top) and two (bottom) of the Au/Ag rod shaped DNA functionalized nanoparticles of FIG. 3b attached to a DNA origami template. The scale bas is 50 nm.

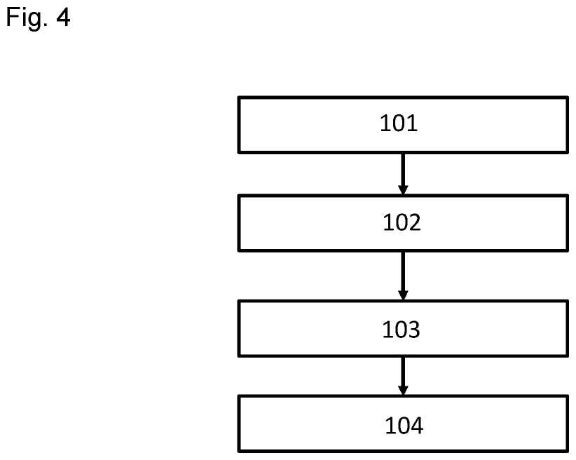

FIG. 4 schematically represents the individual steps 101-104 of preparing the aqueous solution and of starting the wet chemical reaction.

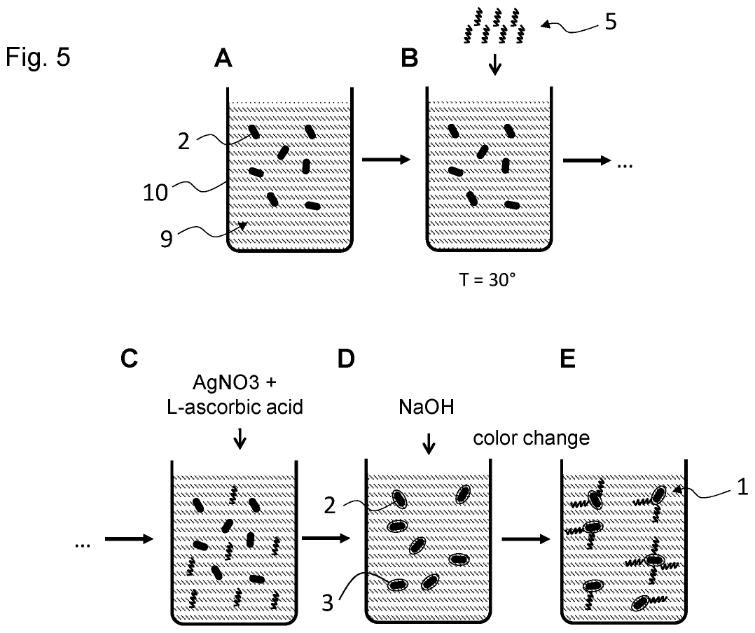

FIG. 5 schematically illustrates a particular embodiment of making the functionalized nanoparticle according to the invention.

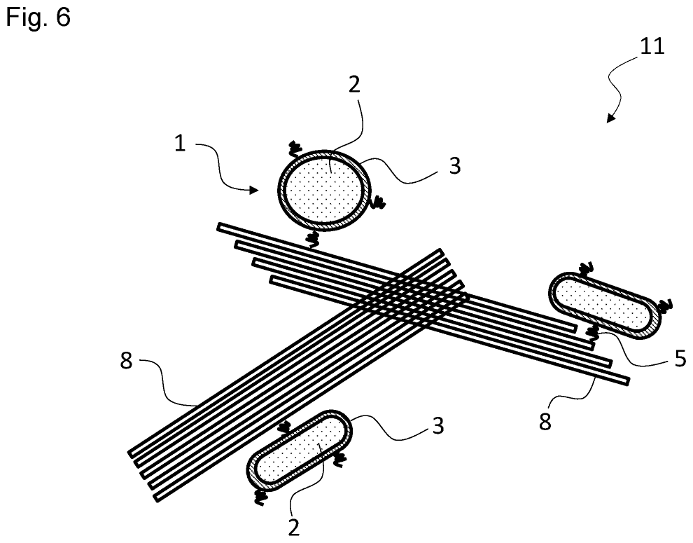

FIG. 6 schematically illustrates an embodiment of the application of the functionalized nanoparticles at a DNA origami pattern.

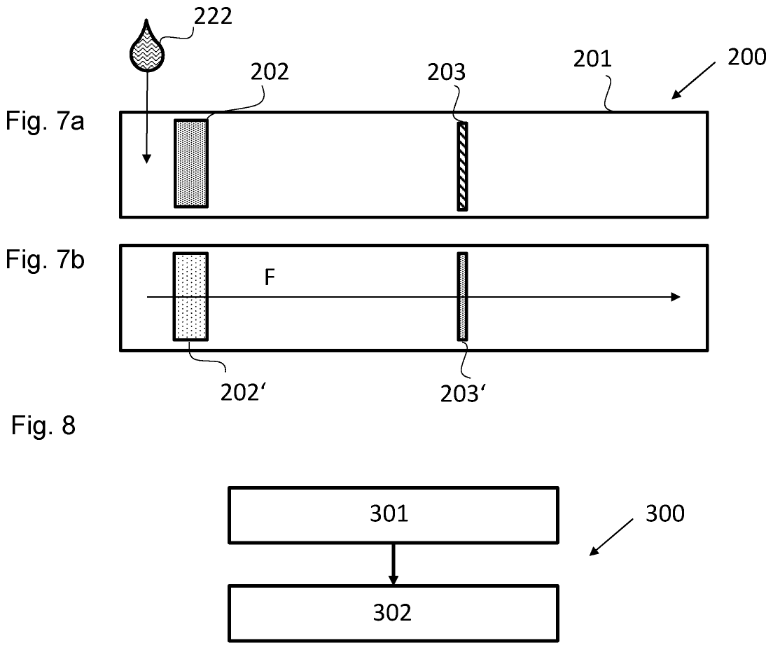

FIG. 7a shows an embodiment of a test device for performing a lateral flow test according to the invention, in a first status of its application.

FIG. 7b shows the test device of FIG. 7a, in a second status of its application.

FIG. 8 shows a diagram describing the method of producing a test device for performing a lateral flow test according to the invention.

FIG. 1 shows a cross sectional view of the functionalized spherical nanoparticle 1 and a functionalized nanorod-shaped nanoparticle 1′ according to an embodiment of the invention having, respectively a spherical or nanorod-shaped metal core 2, 2′, e.g. a core made of Au, marked with dots and a silver coating 3, 3′ shown dashed. The silver coating forms a shell 3, 3′ surrounding the metal core 2, 2′. The silver coating is thin compared to the dimensions of the metal core. The thickness of the silver shell 3, 3′ can be tuned. A lower concentration of, for example Au nanorods 2′ and or a higher concentration of for example, AgNO3 will result in a thicker shell 3′. The silver shell 3, 3′ has several substituents 5, 5′ or ligands are attached to it, as indicated in FIG. 1. The number of substituents 5, 5′ attached to the silver surface may vary. The number of substituents shown in the FIG. 1 does not represent their actual surface concentration. The number of substituents 5, 5′ attached to the silver shell can, for example, be adapted by changing the number of modified substituents (R—SH) in the aqueous solution. The substituents 5, 5′ can form a further layer 4, 4′ surrounding the silver shell 3, 3′. The thickness of the substituent layer 4, 4′ or ligand layer is variable, e.g. depends on the substituent 5, 5′ dimensions, e.g. molecular length or folded structure, e.g. coil shape, when attached. In a most preferred embodiment, a DNA substituent 5, 5′ comprises 19 thymine nucleotides (T19). The further layer 4, 4′ comprising the substituents 5, 5′ also serves to increase stability of the functionalized nanoparticles 1, 1′ in solution, i.e. it acts as a stabilizing layer. In particular when DNA molecules are used as substituents 5, 5′ the solution of functionalized nanoparticles is stable even upon freezing and thawing or upon centrifugation and including re-dilution of the centrifuged particles 1, 1′. The aqueous solution was based on ddH2O. The aqueous solution did not contain bivalent cations, e.g. Ca2+, Mg2+, which is generally preferred for generating the functionalized nanoparticle according to the invention. Preferably, the aqueous solution, in particular for storing the functionalized nanoparticles, contains salt, in particular bivalent cations, in a concentration, each preferably, up to 1 mM, 2 mM, 3 mM, 4 mM, 5 mM.

FIG. 2 shows an enlarged schematic cross sectional view of the functionalized nanoparticle 1, 1′ according to an embodiment of the invention. In the embodiment of FIG. 2, the Au core 2, 2′ of FIG. 1 is indicated by dots as a bottom layer. On top of this layer, the silver shell 3, 3′ of FIG. 1 is formed as indicated by a plurality of circles 6. Each circle 6 indicates an individual silver atom 6 of the shell 3, 3′. The silver atoms 6 are drawn as horizontally neighbored and as packed in a vertical direction. Thereby, the silver layer is formed in the vertical direction by three densely packed layers of horizontally neighbored silver atoms 6. The top silver atom layer relates to the surface of the shell 3, 3′ and is exposed to the aqueous solution. Further, one silver atom 6 of the top silver layer has a sulfide bond formed to it through the sulfur atom 7. The sulfur atom 7 is further covalently bond to the substituent 5, 5′, which in the embodiment shown is a DNA strand 5, 5′. In a preferred embodiment, the tiol is a HS-T19 modified DNA strand. The deposition of silver happens preferentially in certain facets. The geometry due to faceting becomes more apparent, the thicker the Ag shell is. That is the geometry of the grown silver shell deviates more and more from the original geometry of the metal core. For example, the shape of the silver shell initially appears as the original rod shape until it turns towards, e.g. a rhombic shape, when the silver layer is significantly grown.

Further indicated in FIG. 2 is the size of the attached HS-T19 DNA strand, marked as “dDNA”. Also the vertical height of the densely packed silver atom layers 3, 3′ is indicated d_{Ag}. By means of X-ray scattering structural details of the Au/Ag core-shell nanorods in solution can be accessed. In the particular embodiment of FIG. 2 small angle (SAXS) and wide angle (WAXS) X-ray scattering was performed. The SAXS intensities for two geometries are then model fitted considering a cylindrical core-shell-shell particle geometry. From the SAXS data a radius of the Au core of r_{AU}=34 Å with a polydispersity (PD) ratio of 0.1, a thickness of the Ag shell with d_{Ag}=5 Å, and a thickness of the DNA shell with d_{DNA}=29 Å is obtained. Also the length of the Au nanorod core of L_{AU}=155 Å with a PD ratio of 0.3 is obtained. The measured parameters can additionally be compared to the dimensions obtained from transmission electron microscopy (TEM) imaging. Moreover, the SAXS data additionally serve to indicate a closed cover of the Au core 2, 2′ by the silver shell 3. That is the silver shell 3, 3′ forms a continuous layer on the metal core 2, 2′. The Au core 2, 2′ is homogeneously covered by the shell 3, 3′. The SAXS data thus can be used to verify the exclusion of porosity of the Ag shell. The X-ray data further serve to proof binding of the substituent onto the shell.

Further verification of the crystallinity and crystal structure of the Au/Ag core-shell nanorods, and the Au nanorods is obtained by comparison of WAXS data, having the nanorods functionalized with and without DNA substituent 5, 5′. From the WAXS profiles fcc diffraction peaks with a refined lattice parameter for the Au nanorods, a lattice parameter for the Au/Ag nanorods without DNA shell, and a lattice parameter for the Au/Ag nanorods with DNA shell are obtained.

FIG. 3a shows two electron microscopy images in a bottom and a top zoomed view. The images represent the DNA— stabilized Au/Ag core shell nanorods according to one preferred embodiment of the invention. The scale bar is 50 nm. The DNA layer 4′ formed on the surface of the silver shell 3′ of the functionalized nanorods appears as a thin white layer in the top zoom image.

Accordingly, FIG. 3b shows two further electron microscopy images representing a further embodiment of the DNA— stabilized Au/Ag core shell nanorods, wherein the number of attached DNA substituents 5′ on the shell 3′, forming the respective DNA layer 4′ is increased. The feature can be recognized as the white layer 4′ appears brighter. A denser DNA loading is achieved by freezing and thawing the solution containing the functionalized nanoparticles.

Whether the wet chemical reaction is finished appears from optically inspecting the solution after the reaction has started. That is upon silver growth and functionalization a color change of the solution visibly appears. The synthesized DNA— stabilized Au/Ag core shell nanorods are then frozen. The presence of DNA on the particle's surface and in solution prevents the functionalized nanoparticles from aggregation upon freezing. The freezing procedure gives rise to an increased DNA loading owing to the excess DNA. It is noteworthy, that after a removal of the excess DNA the Au/Ag nanorods comprising DNA can be frozen as well, which further demonstrates their stability. In contrast, conventionally stabilized nanoparticles aggregate immediately and irreversibly upon freezing. A further advantage provided here is the possibility of a long-term storage of the Au/Ag nanorods comprising DNA in the frozen state, which makes them equally convenient for use as the Au nanoparticles. Further, neither a change in quality, i.e. stability, nor in their optical properties takes place. Neither, after different freezing durations or freezing and thawing cycles.

In order to determine the number of DNA loaded onto the silver shell and using the method according to the invention, a displacement reaction using dithiothreitol (DTT) can be performed. Upon addition of DTT to the solution comprising the Au/Ag nanorods with DNA attached, the conjugated DNA is released as the DTT exhibits a higher affinity to the metal surface. The Au/Ag nanorods comprising DTT are then removed from the solution by centrifugation and the DNA concentration in the solution can be determined by UV/vis spectroscopy, which then can be related to the concentration of nanorods. Alternatively, fluorescently labeled DNA strands can be used as to-be-displaced molecule to increase the sensitivity.

FIG. 3c shows two electron microscopy images of an embodiment of a functionalized nanorod 1′. In the top image, the DNA functionalized nanorod 1′ is attached to a DNA origami template 8. In the bottom image, two DNA functionalized nanorods 1′ are attached to the origami template 8, wherein the origami template 8 is aligned between the two particles 1′ and along their longitudinal direction. In the particular embodiment shown in FIG. 3c, attachment of the particle 1′ to the actual origami structures 8 occurs via binding of the functional substituent 5′ to both, the silver shell 3′ and the origami structure 8. The origami structure 8 can be any nano structure or nano sized object and the particles 1′ can be either spherical or non-spherical particles prepared according to the method provided by the invention.

FIG. 4 illustrates an embodiment of the individual process steps according to the method of the invention. In a first process step 101 of the claimed method metal nanoparticles 2′, for example Au nanorods, which form the core nanoparticles 2′ are re-dispersed in a CTAB solution. In a second step 102 the thiol-ligand is added in an excess amount along with AgNO₃ and a reducing agent, e.g. L-ascorbic acid, to the as-prepared nanoparticles 2′, e.g. the Au nanorods. In a third step 103 the pH is raised by adding NaOH which initiates the redox reaction. In a fourth step 104, during Ag-shell 3′ growth, the ligand 5′ binds to the Ag-shell 3′ imparting instantaneous stabilization and functionalization. Hence functionalization and stabilization of the grown silver coated metal core nanoparticles 1′ is provided in one step.

The Ag-shell 3′ is grown in the presence of a functional ligand, for example DNA-SH, MPA or mPEG-SH, which allows for their immediate conjugation without having the steric interference of a stabilizer. The stability provided by the ligand 3′ is considerably higher compared to the conventional stabilizers. This can be proven in that the nanoparticles 1′ can be redispersed in different media without having a desorption of the stabilizing layer 4′. A desorption of the stabilizing layer 4′ would result in the aggregation of the nanoparticles 1′. Aggregation can be observed either by bare eye, since the solution becomes optically transparent or means absorption spectroscopy.

FIG. 5 schematically illustrates an embodiment of the method of making a functionalized nanoparticle according to the invention in detail. All chemical ingredients such as HAuCl₄, AgNO₃, CTAB, NaOH, L-ascorbic acid, MgCl₂, sodium citrate, thiol-DNA, SDS, are used as received.

Not shown in FIG. 5 is the synthesis of gold nanorods 2. The synthesis of Au nanorods 2 is carried out following known protocols in literature, for example ACS nano, Vol. 6, 2012, pages 2804-2817, X. Ye, L. Jin, H. Caglayan, J. Chen, G. Xing, C. Zheng, V. Doan-Nguyen, Y. Kang, N. Engheta, C. R. Kagan, C. B. Murray.

Step A: After synthesis of the Au nanorods 2, the Au nanorods 2 were re-dispersed in a solution 9 of 0.1 M CTAB in a beaker 10.

Step B: 5 mL of the Au nanorods 2 22.5 mL of 0.1 M CTAB and 2.5 mL of 100 μM of thiol-modified DNA 5 are added. CTAB crystallizes at room temperature and therefore the mixture is stirred and heated to 30° C. and is kept under this temperature to ensure the dissolution of CTAB.

Step C: 4 mL of 2 mM AgNO3 and 625 μL of freshly prepared 0.2 M L-ascorbic acid are added.

Step D: 1.25 mL of 0.2 M NaOH is added to increase the pH and the reduction potential of L-ascorbic acid. Upon pH increase the wet chemical reaction starts.

Step E: After a few seconds a color change can be observed. The reaction is completed a few minutes after the color change. The obtained stable Au/Ag core-shell functionalized nanorods 1 are further isolated from the reaction solution by 4-times centrifugation, for example at 5000 rpm (2350 rcf) depending on the particles size for 20 min and re-dispersion in 0.1% SDS (not shown).

FIG. 6 illustrates an embodiment wherein the functionalized nanoparticles 1, 1′ according to the invention are attached to a nano structure 8. Attaching the nanoparticles 1, 1′ to the nano structure 8 is accomplished through the substituents 5, 5′. Thereby different types of nanoparticles, e.g. nanorods and nanospheres are used, each having respective metal cores 2, 2′ and a silver shell 3, 3′. In the particular embodiment shown in FIG. 5 the nano structure 8 is an origami template, in particular a DNA origami, wherein the functionalized nanoparticles 1, 1′ are attached to form a nano object 11. Several nano objects 11 can be obtained by attaching the nanoparticles 1, 1′ to them, whereas the individual nano objects 11 are distinguishable by different chirality. A solution containing for example the plurality of the produced nano objects 11 is optically active in a way that polarized light passing through the solution will be rotated. Alternatively, the nanoparticles 1, 1′ can be attached onto a surface, in particular attached to a surface according to a predefined pattern, whereas selective adsorption of the nanoparticles 1, 1′ along the predefined pattern occurs through the nanoparticle functionalization. The attached nanoparticles 1, 1′ then serve through their silver metal properties to guide or scatter a light beam towards a certain direction.

In an another application of the functionalized nanoparticles 1, 1′ fluorophores are further attached to the substituents 5, 5′ and the functionalized nanoparticles 1, 1′ are then used as marker molecules to observe selective binding reactions, in particular binding of medical agents, whereas long time studies are possible, because of the achieved enhanced stability of the functionalized nanoparticles 1, 1′ provided by the invention. Before the actual use of the specifically labeled functionalized nanoparticles 1, 1′, the particles 1, 1′ can be readily synthesized, labeled with fluorophores and stored by freezing without losing their advantageous effects.

While above at least one exemplary embodiment of the present invention has been described, it has to be noted that a great number of variation thereto exists. Furthermore, it is appreciated that the described exemplary embodiments only illustrate non-limiting examples of how the present invention can be implemented and that it is not intended to limit the scope, the application or the configuration of the herein-described nanoparticles and methods relating thereto. Rather, the preceding description will provide the person skilled in the art with constructions for implementing at least one exemplary embodiment of the invention, wherein it has to be understood that various changes of functionality and the arrangement of the elements of the exemplary embodiment can be made, without delegating from the subject-matter defined by the appended claims and their legal equivalents.

FIG. 7a shows a test device 200 for performing a lateral flow test according to the invention, in a first status of its application. FIG. 7b shows the test device 200 of FIG. 7a, in a second status of its application. The test device comprises a test strip 201, made from a porous material, e.g. containing cellulose. The porous material has the ability to let a fluid sample 222, for example a medical body liquid, or an aqueous dilution containing the same, flow along a direction F parallel to a length axis of the test strip 201, driven by capillary forces. In a region 202 of the test strip, the functionalized nanoparticles according to the invention (or in case of multiplexing: different groups of different functionalized nanoparticles) are located, acting as visual markers for specifically binding to a target.

The test device is preferably configured to perform a so-called sandwich assay. Sandwich assays may be generally used for larger analytes because they tend to have multiple binding sites. As the fluid sample 222 migrates through the test strip it first encounters a conjugate, which is an antibody specific to the target analyte labelled with the visual marked, which is a functionalized nanoparticle according to the invention. The antibodies bind to the target analyte within the sample fluid and migrate together until they reach the test line 203. The test line 203 also contains immobilized antibodies specific to the target analyte, which bind to the migrated analyte bound conjugate molecules. The test line then presents a visual change 203′ due to the concentrated visual marker, hence confirming the presence of the target molecules. In case of multiplexing, different groups of different nanoparticles are provided in region 202, and different test lines 203 are located at different positions along the length of the test strip.

FIG. 8 shows a diagram describing the method of producing a test device for performing a lateral flow test according to the invention, including the steps of providing a test substrate; (301) and applying to the test substrate a plurality of functionalized nanoparticles according to the invention and/or a nanoscale object according to the invention (302).

### LIST OF REFERENCE SIGNS

1 Functionalized nanoparticle
2 Metal core
3 Silver coating
4 Substituent layer
5 Substituent
6 Silver atom
7 Sulfur atom
8 Nano structure
9 Solution
10 Beaker
11 Nano object
200 Test device
201 Test substrate
202 Region containing the functionalized nanoparticles plus its mobile conjugate
203 Test lines with immobilized antibodies for letting the conjugate bind to the antibodies
300 Method of producing the test device
301, 302 method steps of method 300

1. A method of preparing a functionalized nanoparticle, comprising a metal core, a silver coating and a sulfide bond substituent, in an aqueous solution, the method comprising a step of chemical functionalization of a metal nanoparticle in the aqueous solution, wherein the aqueous solution comprises water and ingredients, wherein the ingredients comprise the metal nanoparticle, a thiol of the form R—SH, where R represents an organic substituent having a functional group, and a silver compound.

2. The method according to claim 1, wherein silver of the silver compound is deposited on the metal nanoparticle by wet chemical reaction.

3. The method according to claim 1, wherein the ingredients are provided in one step, wherein, in particular, a plurality of the metal nanoparticles is functionalized such that aggregation of the plurality of functionalized nanoparticles is prevented after the wet chemical reaction has finished.

4. The method according to claim 1, wherein the organic substituent comprises an oligonucleotide, a Polyethylene glycol (PEG or mPEG), or MPA.

5. The method according to claim 1, wherein the metal nanoparticles provided comprise nanospheres and/or nanorods.

6. The method according to claim 1,
wherein the functional group comprises a carboxyl group, an aldehyde group, a hydroxyl group, an amino group, or an amide group.

7. A plurality of functionalized nanoparticles, wherein each of the plurality of functionalized nanoparticles comprises
a metal core,
a silver coating and
a sulfide bond substituent.

8. The plurality of functionalized nanoparticles according to claim 7, wherein the metal core comprises one or more of the following metals: Au, Ag, Al, Pt, Pd, Cu, Rh, Fe.

9. The plurality of functionalized nanoparticles according to claim 7, wherein the silver coating of each of the functionalized nanoparticles forms a shell around the metal core and the metal core is at least partially covered by the silver shell.

10. The plurality of functionalized nanoparticles according to claim 7, wherein the sulfide bond substituent protrudes from the silver coating.

11. The plurality of functionalized nanoparticles according to claim 7, wherein the sulfide bond substituent exceeds the thickness of the silver coating.

12. A plurality of functionalized nanoparticles, wherein each of the functionalized nanoparticles comprises
a metal core,
a silver coating and
a sulfide bond substituent, and
wherein each functionalized nanoparticle is synthesized by a method of preparing a functionalized nanoparticle in an aqueous solution, comprising a step of chemical functionalization of a metal nanoparticle in the aqueous solution, wherein the aqueous solution comprises water and ingredients, which are selected from the group consisting of the metal nanoparticle, a thiol of the form R—SH, where R represents a substituent, and a silver compound.

13. A nanoscale object functionalized with at least one functionalized nanoparticle synthesized by the method according to claim 1.

14. A test device for performing a lateral flow test, which contains a test substrate including a plurality of functionalized nanoparticles according to claim 7.

15. (canceled)

16. The method according to claim 1, wherein the organic substituent comprises one or more of an amino acid, a protein, an antibody, a virus, and a hormone.

17. The method according to claim 1, wherein the silver forms a shell around the metal nanoparticle.

18. The method according to claim 17, wherein the thiol attaches onto the silver of the silver shell by forming a sulfide bond with the silver of the shell.

19. The method according to claim 4, wherein the oligonucleotide is an RNA, a PNA, or a DNA.

20. The method according to claim 4, wherein the oligonucleotide comprises sequences of bases selected from adenine (A), cytosine (C), guanine (G) or thymine (T).

21. The plurality of functionalized nanoparticles according to claim 7, wherein the sulfide bond substituent comprises an oligonucleotide, a polyethylene glycol (PEG or mPEG), or MPA.


SEQUENCE LISTING (7 sequences)

SEQ ID NO: 1 - DNA, 19 bp, Artificial Sequence
  T19
ttttttttttttttttttt

SEQ ID NO: 2 - DNA, 15 bp, Artificial Sequence
  T15
ttttttttttttttt

SEQ ID NO: 3 - DNA, 19 bp, Artificial Sequence
  A19
aaaaaaaaaaaaaaaaaaa

SEQ ID NO: 4 - DNA, 19 bp, Artificial Sequence
  G19
ggggggggggggggggggg

SEQ ID NO: 5 - DNA, 19 bp, Artificial Sequence
  C19
ccccccccccccccccccc

SEQ ID NO: 6 - DNA, 17 bp, Artificial Sequence
  Random1
ttctctaccacctacat

SEQ ID NO: 7 - DNA, 16 bp, Artificial Sequence
  Random2
ttaatctcgcaacagg